(19) United States
(12) Patent Application Publication
(10) Pub. No.: US 2015/0360972 A1
(43) Pub. Date: Dec. 17, 2015

(54) AN EVAPORATOR FOR TREATING WATER

(71) Applicant: I.D.E. TECHNOLOGIES LTD., Kadima (IL)

(72) Inventors: Erez REUVENI, Kibbutz Ein Hahoresh (IL); Henrikh ROJANSKIY, Rishon L'Zion (IL); Yaniv SCHMIDT, Hod Hasharon (IL); Elazar SCHWARCZ, Netanya (IL); Yony WEISS, Moshav Misgav Dov (IL); Deyan YULZARI, Kfar Saba (IL); Roi ZAKEN, Jerusalem (IL)

(21) Appl. No.: 14/763,749

(22) PCT Filed: Jan. 21, 2014
(86) PCT No.: PCT/IB2014/058441

§ 371 Date: Jul. 27, 2015

(30) Foreign Application Priority Data
Jan. 27, 2013 (GB) 1301400.6

(51) Int. Cl. C02F 1/04; B01D 1/04; F28G 7/00; F28D 3/02; F28F 9/00; F28G 1/16; B01D 1/30; B01D 1/26

(52) U.S. Cl. CPC C02F 1/048; B01D 1/30; B01D 1/04; B01D 1/26; B01D 1/305; F28D 3/02; F28F 9/00; F28G 1/166; F28G 7/00; C02F 2103/10

(57) ABSTRACT

An evaporator having an external vessel and an inner cavity, and a heat exchanging tube assembly, the external vessel comprising an opening closable by a hatch, the heat exchanging tube assembly being insertable into and removable from the inner cavity through the opening. In oil production and in other industrial processes, waste water is often produced which requires treatment. This water may be contaminated with amongst other contaminants Oil & Grease, minerals, Silica, and organic contamination.

### TECHNICAL FIELD

This invention relates to an evaporator for treating industrial waste water or produced water of an oil or gas production plant.

### BACKGROUND OF THE INVENTION

In oil production and in other industrial processes, waste water is often produced which requires treatment. This water may be contaminated with amongst other contaminants Oil & Grease, minerals, Silica, and organic contamination. It is desirable to treat the water, both for possible recycling into the industrial process or to reduce or minimize disposals and environmental effects, often in accordance with environmental regulations.

As part of such as treatment process, it is known to pass the water through an evaporator. This produces a stream of distillate, or purified water, and a blowdown of water with a much higher concentration of contaminants. Such evaporators have a heat transfer area, an array of heat exchange tubes or plates, and water to be treated is sprayed over these tubes or plates in a “falling film” configuration. Where contamination is present, scaling and fouling deposits form on the heat exchanging surfaces which reduce the thermal efficiency and the water treatment capacity of the evaporator and increase its energy consumption.

Conventionally, to deal with such scaling and fouling in evaporators, it is necessary to take the evaporator out of operation and perform chemical washes inside the vessel which has a limited efficiency in scaling and fouling removal. Unlike evaporators, heat exchangers may be disassembled to remove heat exchange tubes bundle in order to be cleaned in an external cleaning device. This may either be an ultrasonic bath or a high flow-rate spray system, in which a suitable treatment fluid is sprayed onto the tubes at a high rate to remove the scaling. Such cleaning processes are themselves expensive, and also impose costs on the industrial plant in terms of lost production during shutdown of the evaporator

### SUMMARY OF THE INVENTION

According to a first aspect of the invention is provided an evaporator for treating industrial waste water or produced water, having an external vessel and an inner cavity, and a heat exchanging tube assembly, the external vessel comprising an opening closable by a hatch, the heat exchanging tube assembly being insertable into and removable from the inner cavity through the opening.

The hatch may comprise a first upturned lip, and a wall adjacent the hatch may comprise a second upturned lip, wherein the first and second upturned lips may abut when the hatch closes the opening.

The hatch may comprise a first connection plate, and a wall adjacent the hatch may comprise a second connection plate, wherein a plurality of connection elements may engage the first connection plate and second connection plate to maintain the hatch in a closed position.

The connection elements may comprise a plurality of bolts.

The connection elements may be mounted such that the total vector of forces on the hatch and the adjacent wall extends generally longitudinally of the connection elements.

A sealing element may be engaged between the first connection plate and second connection plate.

The heat exchanging tube assembly may comprise a first end tube sheet, a second end tube sheet and a plurality of heat exchange tubes received in the first end tube sheet and second end tube sheet.

The evaporator may comprise support elements disposed in the cavity engage the first end tube sheet and second end tube sheet.

The evaporator may further comprising a lifting frame, the lifting frame having a first end part for connection to the first end tube sheet, a second end part for connection to the second end tube sheet, and a rigid frame extending between the first end part and second end part, wherein the lifting frame may be releasably connectable to the heat exchanging tube assembly to permit it to be inserted into or removed from the inner cavity.

The evaporator may comprise a plurality of openings, each opening closable by a hatch

According to a second aspect of the invention, there is provided an evaporator having a heat exchanging tube assembly, and a first plurality of nozzles disposed to introduce water to the heat exchanging tube assembly during normal operation, the evaporator comprising a second plurality of nozzles, the second plurality of nozzles being disposed to introduce cleaning fluid to the heat exchanging tube assembly during cleaning operation.

The evaporator may comprise a first main feed connected to the first plurality of nozzles and a second main feed connected to the second plurality of nozzles.

The first plurality of nozzles may be located to form a falling film of water over the heat exchanging tube assembly, and the second plurality of nozzles may be offset from the first plurality of nozzles.

The evaporator may comprise an external vessel having an opening closable by a hatch, and the first main feed and second main feed may be mounted on the hatch.

At least some of the first plurality of nozzles and the second plurality of nozzles may be mounted on the hatch.

The second plurality of nozzles may further comprise nozzles to direct fluid at the sides of the heat exchanging tube array.

According to a further aspect of the invention there is provided an evaporator comprising an external vessel having a longitudinal axis, the vessel comprising a plurality of longitudinal extending walls, said longitudinally extending walls being curved in a plane transverse to said longitudinal axis

The plurality of walls may comprise a base wall and opposed side walls

The base wall and opposed side walls may be formed integrally.

The opposed side walls may alternatively be welded to the base wall.

The evaporator may comprise an opening closable by a hatch.

The hatch may comprise a curved top wall.

The hatch may comprise a first upturned lip, and a wall adjacent the hatch may comprise a second upturned lip, wherein the first and second upturned lips may abut when the hatch closes the opening.

The hatch may comprise a first connection plate, and a wall adjacent the hatch may comprise a second connection plate, wherein a plurality of connection elements may engage the first connection plate and second connection plate to maintain the hatch in a closed position.

The connection elements may comprise a plurality of bolts.

The connection elements may be mounted such that the total vector of forces on the hatch and the adjacent wall extends generally longitudinally of the connection elements.

A sealing element may be engaged between the first connection plate and second connection plate.

In any embodiment of the invention, the evaporator may comprise a single preassembled module which can be transportable using a standard vehicle.

The evaporator may comprise a compressor having an inlet.

The evaporator may comprise a demister to remove entrained water droplets before the inlet.

The demister may comprise a plurality of horizontal louvers.

The demister may comprise a plurality of horizontal knitmesh elements.

The demisters may be washed thorough a designated spraying system, by caustic or other chemicals

The evaporator may comprise a plurality of effects, each effect comprising a heat exchanging tube assembly and an associated plurality of nozzles.

The evaporator may comprise a plurality of ultrasonic transducers to permit ultrasonic cleaning of the heat exchanging tube assembly

The evaporator may comprise an inner cavity and a deflector plate to retain fluid within the inner cavity to immerse the heat exchanging tube bundle to permit ultrasonic cleaning.

According to a further aspect of the invention there is provided an oil production apparatus, the oil production apparatus comprising a water recovery apparatus, the water recovery apparatus comprising an evaporator array according to any preceding aspect of the invention.

According to a further aspect of the invention there is provided a method of cleaning a heat exchanging tube or plate array for an evaporator, comprising the steps of removing a hatch which closes an opening provided in an external vessel of the apparatus, removing the heat exchanging tube or plate array, cleaning the heat exchanging tube or plate array, inserting the heat exchanging tube or plate array in the external vessel through the opening, and closing the hatch.

According to a further aspect of the invention there is provided method of cleaning a heat exchanging tube array for an evaporator, where the evaporator has a first nozzle array for introducing produced water and a second nozzle array, the method comprising the step of introducing a cleaning fluid to the heat exchanging tube array through the second nozzle array.

According to a further aspect of the invention there is provided method of cleaning a heat exchanging tube array for an evaporator, where the evaporator has a plurality of ultrasonic transducers and an external vessel defining an internal cavity, the method comprising the steps of introducing fluid in to the internal cavity to immerse the heat exchanging tube array, and operating the ultrasonic transducers.

### BRIEF DESCRIPTION OF THE DRAWINGS

Embodiments of the invention will now be described by way of example only with reference to the accompanying drawings wherein;

FIG. 1 is a perspective view of an evaporator assembly embodying the present invention,

FIG. 2a is a further perspective view of the evaporator assembly of FIG. 1,

FIG. 2b is a perspective view of an evaporator vessel of the evaporator assembly of FIG. 1,

FIG. 3 is a perspective view of a hatch of the evaporator assembly of FIG. 1,

FIG. 4 is a section on line 4-4 of FIG. 1,

FIG. 5 is a view on an expanded scale of part of FIG. 4, showing a seal assembly of the evaporator of FIG. 1,

FIG. 6a is an illustration of the forces acting on the cross-section of FIG. 4 in negative-pressure operation,

FIG. 6b is an illustration of the forces acting on the cross-section of FIG. 4 in positive-pressure operation,

FIG. 7 is a perspective view of the evaporator assembly of FIG. 1, illustrating removal of a bundle of heat exchanging tubes,

FIG. 8 is a partial longitudinal section of he evaporator assembly of FIG. 1,

FIG. 9 is a view in more detail of parts of FIG. 8,

FIG. 10 shows the view on a larger scale of FIG. 9 in a second operating position,

FIG. 11 is a further view on a larger scale of part of FIG. 8,

FIG. 12 is view of a further part of FIG. 8 on a larger scale,

FIG. 13 is a diagrammatic side view of a further embodiment of an evaporator,

FIGS. 14a and 14b comprise a longitudinal section through a further evaporator assembly embodying the present invention,

FIGS. 15a and 15b form a plan view of the evaporator assembly of FIGS. 14a and 14b, and

FIG. 16 is a diagrammatic illustration of alternative cleaning processes.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated n the drawings. The invention is applicable to other embodiments or of being practiced or carried out in various ways. Also, it is to be understood that the phraseology and terminology employed herein is for the purpose of description and should not be regarded as limiting.

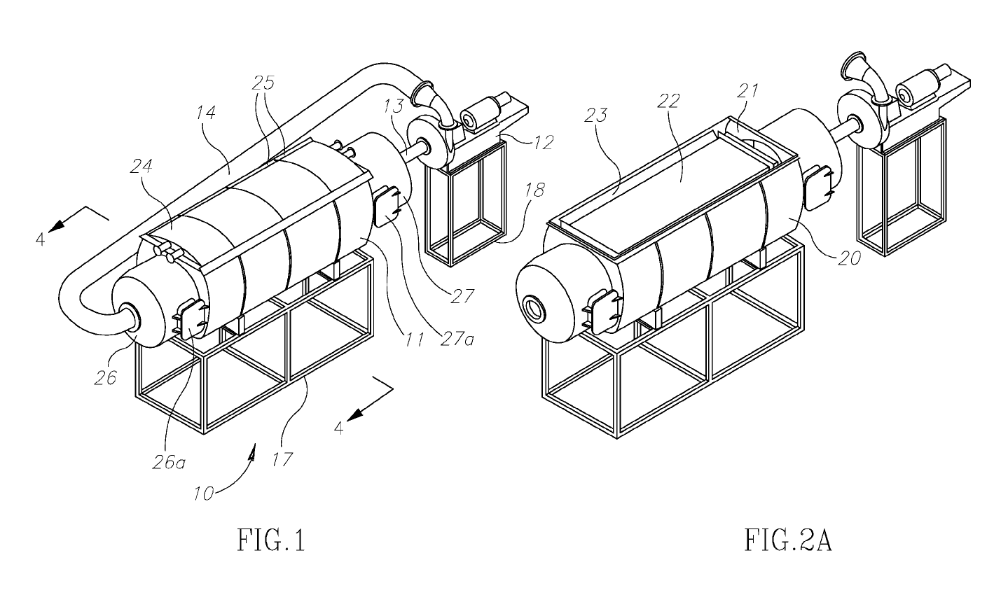

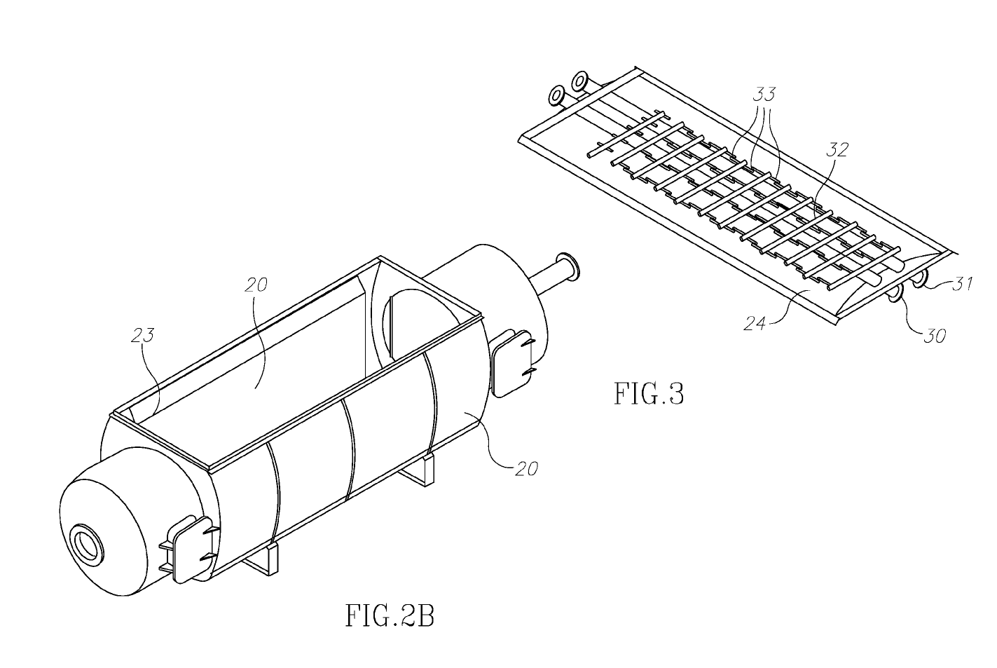

Referring now to FIG. 1 to FIG. 4, an evaporator assembly 10 embodying the present invention is illustrated. As shown in the figures, the assembly 10 includes an evaporator 11 and a compressor 12 which receives steam from the evaporator through an inlet pipe 13, and returns steam to the far end of the evaporator 11 via pipe 14 to circulate steam through the heat exchanging tube assembly or bundle 22 within the evaporator 11. Heat exchanging tubes may be made of stainless still, aluminum, titanium or other metals or alloys. internal or external coating materials may be practiced in order to coat internal or external heat exchanging tube's surface to better withstand working and cleaning corrosive conditions. Ceramic on metal coating may be practiced. Aluminum tubes may be coated with alumina coating, followed by a sealer coating to seal the alumina pores. Such a sealer improves the alumina resistance to corrosion and better protects the aluminum tubes. In addition, the alumina coating, together with the sealer reduces the tubes surface roughness and therefore reduces amount of foaling and scaling deposits. The evaporator 11 comprises an outer vessel 20 which has an internal cavity 21. As illustrated in FIG. 2, the heat exchanging tube bundle 22 is received in this cavity 21. The upper part of the vessel 20 has an opening or hatchway 23 which in operation is sealingly closed by hatch 24. The hatch 24 is held in place by a plurality of bolts 25 in a configuration discussed in more detail below.

At either end of the evaporator vessel 20 are provided a first end part 26 and a second end part 27, each provided with a corresponding inspection hatch 26a, 27a, respectively. End part 27 houses a demister to remove water droplets from the steam stream. In addition, end part 27 may house a third nozzles array connected to and fed by a third feeder tube. This third and optional nozzle array may be dedicated to clean the demisters and knit mesh. An example demister will be discussed in more detail below.

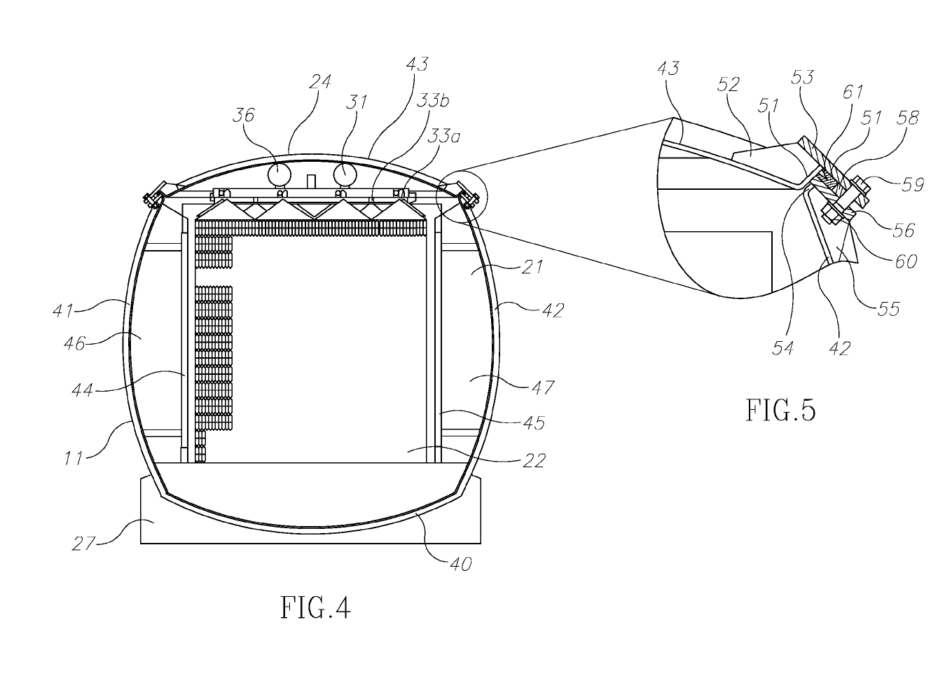

Referring now to FIG. 3 and FIG. 4, the hatch 24 will be discussed in more detail. In FIG. 3, the hatch 24 is shown upside down, i.e. with that surface which faces towards the cavity 21 in operation shown here uppermost. The hatch 24 is provided with first header tube 30 and second header tube 31. Mounted on the underside of the hatch 24 are a plurality of secondary header ribs 32, each of which is connected to at least one further nozzle 33. Each secondary header rib is connected to only one of the first main header tube 30 or second main header tube 31. Accordingly, the nozzles 33 are separated into two pluralities of nozzles 33, a first plurality 33a which is in flow communication with the first header tube 30 and a second plurality 33b which is in flow communication with the second header tube 31. The first plurality 33a of nozzles 33 is configured to spray produced or waste water on top of the heat exchanging tubes bundle in order to produce a falling film around the heat exchanging tube bundle 22 in known manner. As is known, the arrangement of the nozzles 33 in the first nozzle array 33a is designed to optimally produce a falling film of water and provide optimal heat transfer.

The second array 33b of nozzles 33 is configured to spray the heat exchanging tube bundle 22 with a suitable cleaning or descaling fluid. It might be envisaged that further nozzles may be provided to at least one side of the heat exchanging tube bundle 22 in flow communication with the second main header 31 to use supply cleaning fluid to the side of the heat exchanging tube bundle 22.

Preferably, the second array 33b of nozzles 33 is located in such a way as to not disturb or interfere with the optimal placing of the first array 33a of nozzles 33. This may be achieved, for example, in the present case by the nozzles 33 of the second nozzle array 33b being laterally or longitudinally offset from the nozzles 33 of the first nozzle array 33a. The nozzles 33 of the second nozzle array 33b may be adapted to suit the nature of the cleaning fluid, for example by being made of an appropriate alloy to accommodate a cleaning fluid comprising a concentrated acid with a low pH.

In a number of alternatives, it will be apparent that a hatch 24 may be provided without the second main header 31 and without a second nozzle array. In this example, the heat exchanging tube bundle 22 may be cleaned either by removing the bundle 22 and subjecting it to an external cleaning process as discussed in more detail below, or by supplying a cleaning fluid through the first main header 30 and the plurality of nozzles 33a. In a further alternative, it will be apparent that an evaporator may be provided with an array of nozzles 33 having first and second main headers 30, 31, but these need not necessarily be provided as part of or in combination with a hatch 24 and indeed in such circumstances the hatch 24 may be omitted altogether.

As discussed in more detail below, advantageously the evaporator 11 is manufactured as a single and preassembled module with such dimensions that it can be transported as an integral unit on a single standard vehicle. In this example, by ‘standard vehicle’ is meant a truck or other transporter within the applicable legal size and/or weight limits, preferably without requiring modification to transport the evaporator 11. Advantageously, the evaporator 11 can be transported as a single unit to a site and installation assembly required that the evaporator 11 and the associated compressor 12 be mounted on appropriate, modular frames or supports 17, 18, respectively. Installing a preassembled and transportable evaporator unit may reduce construction efforts and complexity in the target operational industrial site.

Referring now to FIG. 4, a section through the evaporator assembly 11 is shown in more detail. The evaporator vessel 20 is supported on transverse base parts 27. The evaporator vessel 20 is made up of four similar concave walls, a base wall 40, side walls, 41, 42, and an upper wall 43 provided by the hatch 24. In this example, the walls 40, 41, 42, 43 extend longitudinally of the evaporator vessel 20 and are curved in the plane transverse or perpendicular to the longitudinal axis of the vessel (while being essentially or substantially parallel to the longitudinal axis over the majority of their lengths). The “curved square” geometry is desirable because it maximises the volume available within the evaporator 11 while keeping its dimensions small enough to enable the evaporator 11 to be transported on a single vehicle. A completely circular cross-section would be strongest but would result in a loss of internal volume. Similarly, a square cross-section would maximise the possible internal volume but would be weakest during both the negative and positive pressure operations of the evaporator and vulnerable to failure at wall edges. In the present example, the evaporator vessel 20 has a width of 2557 mm, a height of 2569 mm and a length of 8924 mm. The vessel 20 has a weight of about 7500 kg, the hatch 24 weighs about 2000 kg and the heat exchanging tube assembly 22 weighs about 6000 kg. Consequently, the evaporator 11 may be transported as a single complete preassembled module.

The base wall 40 and side walls 41, 42 may be formed integrally from a single metal sheet, by appropriate bending and folding. Alternatively, the side walls 41, 42 may be formed separately and welded to the base wall 40. The heat exchanging tube bundle 22 is located in the cavity 21 between side deflectors 44. The side deflectors 44 are spaced from the side walls 41, 42 to define steam suction channels 46, 47 respectively. Vapour created in the heat exchange tube bundle 22 is evaporated from the bottom of the vessel cavity 21 into the side steam suction channels 46, 47 and are then drawn towards the compressor. Where the evaporator is provided with a second nozzle array 33b, additional nozzles of the second nozzle array 33b may be mounted on the side deflectors.

To provide a strong, sealing and releasable connection between the hatch 24 and side walls 41, 42, a closure assembly is provided generally shown at 50 in FIG. 5. In FIG. 5, the junction between the top wall 43 provided by the hatch 24 and the right concave side wall 42 is shown. At its edge, the upper wall 43 is provided with an upturned lip 51 which is supported and held in place by a plurality of transversely extended flanges 52. Connection plate 53 is mounted to the upper edge of the flanges 52 and extends over the junction between concave walls 42, 43.

In a similar manner, side wall 42 has an out-turned lip 54 which extends a shorter distance than lip 51. Out-turned lip 54 is held in place by a plurality of mildly extending flanges 55, which have a further connector plate 56 which extends longitudinally of the opening 25. Disposed between the upper and lower connection plates 53, 56 is a V-shaped seal 57 and a spacer 58. Bolts 59 pass through the upper and lower connection plates 53, 56 and are releasably held in place by nuts 60 received on the bolts 59. Bolts 59 are located at spaced intervals around the edges of the hatch 24, for example every 10 cm. The seal 57 generally extends around the periphery of the hatch 24 to ensure a complete seal. The notch 61 in the V-shaped seal 57 faces towards the out-turned lip 51. In the event of any pressurized fluid escaping through the junction between the lips 54, 51, the arms on either side of the notch 61 will be forced against the respective upper and lower plates 53, 56, ensuring a good seal.

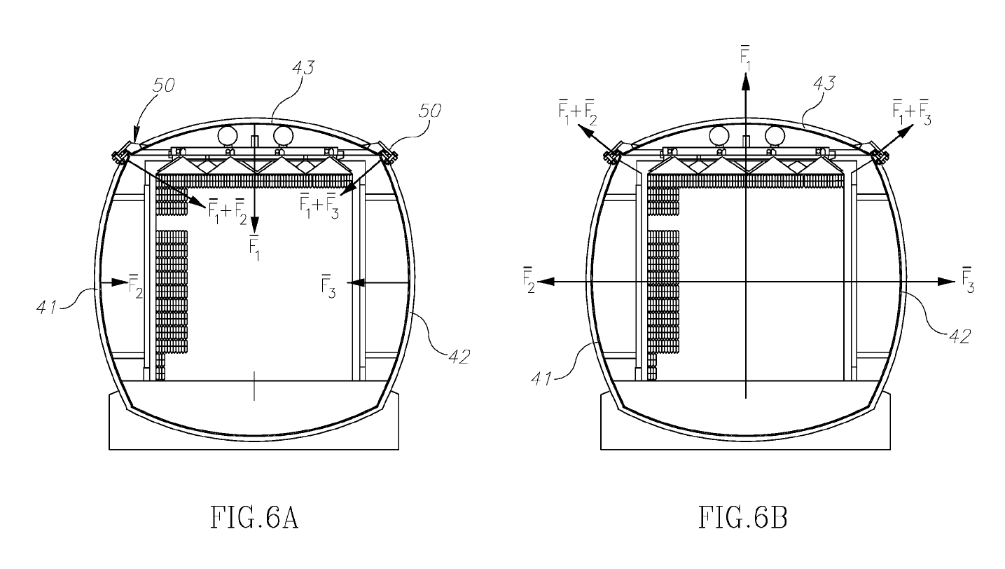

As illustrated in FIGS. 6a and 6b, the orientation of the bolts 59 is selected such that the axis of the bolt extends along the product of the forces acting on the respective adjacent side wall 41, 42 and top wall 43. As shown in FIG. 6a, when the evaporator is operating at a negative pressure with respect to the ambient pressure, each of the walls 40, 41, 42, 43 experiences an inward force. The longitudinal axis of the bolts 59 is aligned with the sum of the forces acting on the two walls meeting at the respective joint. Similarly, as shown in FIG. 6b when the evaporator is at its operating positive pressure of approximately 1 atmosphere, the walls 40, 41, 42, 43 experience an outward force and the axes of the bolts 59 are aligned with the total force vector acting at the joint as a result of the forces on the adjacent walls.

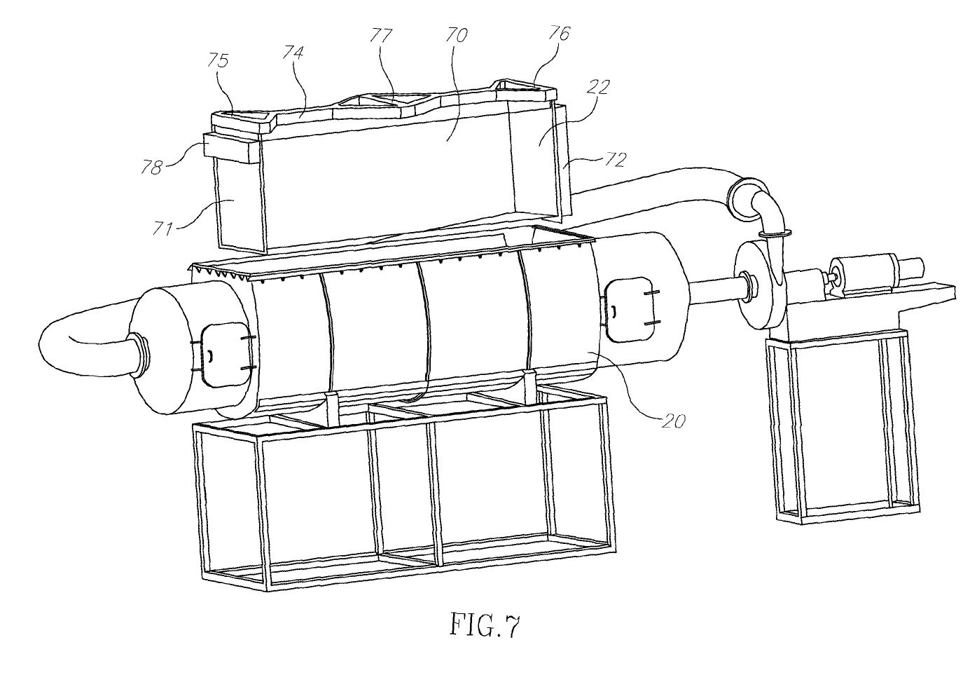

Removal and insertion of the heat exchanging tube bundle 22 will now be discussed with reference to FIG. 7 to FIG. 12. The heat exchanging tube bundle 22 contains a plurality of closely spaced heat exchange tubes 70 (shown as a block in FIG. 7 for clarity) supported at either end by tube sheets 71, 72. It will be apparent that, in the preferred example, there are no transversely extending supports or sheets between end tube sheets 71, 72 as it is desirable that this region be clear to permit longitudinal movement of steam within the heat exchange bundle 22. In addition, the tubes need not be rigidly mounted to one or more of the tube sheets 71, 72. For example, it is known to receive the end of each tube in a rubber mount, for example an H-shaped rubber mount, which is then received in a hole in the respective tube sheet 71, 72.

To allow the heat exchange tube bundle 70 to be safely lifted, a lifting frame 74 is preferably provided. The lifting frame 74 has a first end part 75, for connection to the first tube sheet 71, and a second end part 76 for connection to the second tube sheet 72. The first and second end parts 75, 76 are rigidly interconnected by a suitable frame 77. By connecting the first end part 75 to the first tube sheet 71 and the second end part 76 to the second tube sheet 72 the components of the heat exchange bundle 70 are held in a fixed, rigid orientation and can be safely removed from the evaporator vessel 20 or inserted into the vessel 20.

To assist in accurately locating the heat exchanger tube bundle 22 in the evaporator vessel 20, a plurality of support and alignment points are provided. A support bar 78 is provided on the first tube sheet 71 whilst each of the first and second tube sheets 71, 72 have a downwardly extending bottom part 71A, 72A respectively. As seen in FIG. 9 and FIG. 10, the evaporator vessel 20 has a slidably movable inner end wall 80. A guide pin 81 extends downwardly from the bottom end of the inner end wall 80 and is slidably movable in a slot 82 provided in a horizontally extending flange 83 which is supported by support wall 84. At its lower end, the inner end wall 80 has an engagement part 85 which includes an adjustable seal 86. The projection of the seal beyond the engagement part 85 may be controlled using a screw 87.

As shown in FIG. 9, when the inner end wall 80 is in the engaged position, the seal 86 abuts the side face of the lower part 71a of the tube sheet 71, providing a seal between the tube sheet 71 and the inner end wall 80 and providing a lateral force acting on the tube sheet 71 to assist in holding the heat exchange bundle 22 in place. As shown in FIG. 10, when it is desired to remove or insert heat exchange tube bundle 22, the inner end wall 80 is moved to the left as shown in the figure, disengaging the seal 86 and end part 71a of the tube sheet 71 and allowing movement of the heat exchange bundle 22.

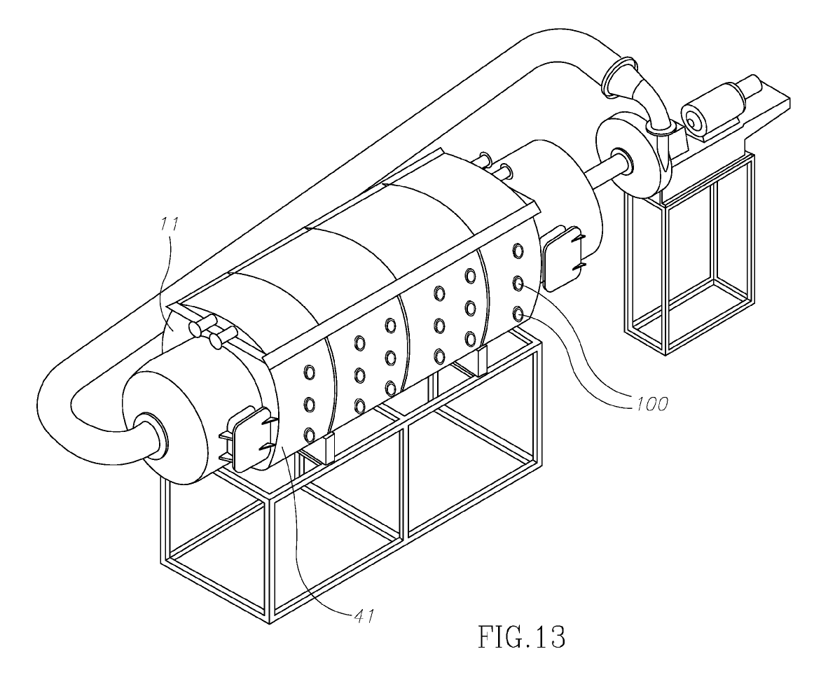

As seen in FIG. 11, a transverse flange 90 with an upwardly extending seal element 91 engages and supports the support bar 78 to support the heat exchange tube bundle 22 at a particular vertical orientation. As shown in FIG. 12, a bundle support 92 extends upwardly from the base of the reactor vessel 22. The bundle support 92 has a notch 93 at an upper part thereof which receives the lower part 72a of the second tube sheet 72 in a correct orientation.

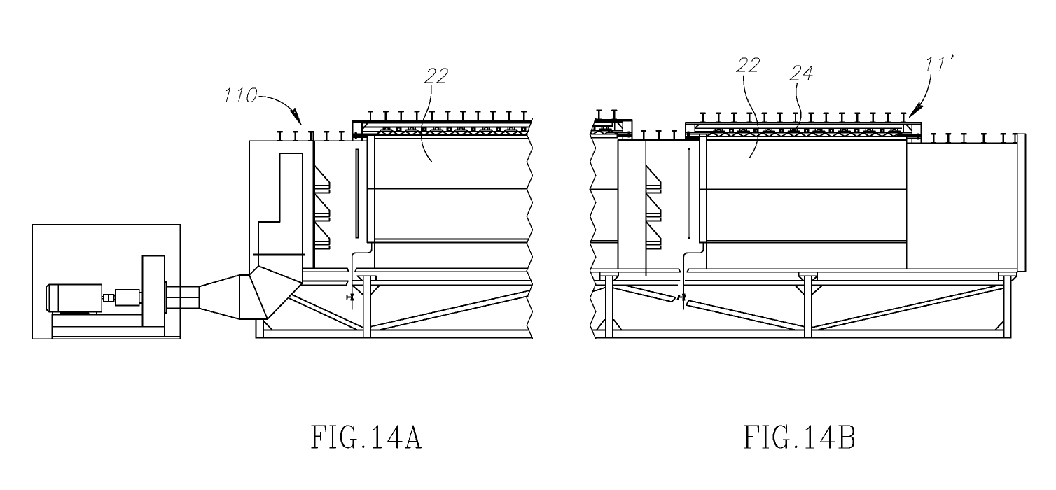

As will be discussed in more detail below, in one alternative it may be desirable for ultrasonic cleaning to take place within the evaporator vessel 20 without needing to remove the heat exchanger tube bundle 22. Ultrasonic cleaning operates by inducing cavitation in an immersing liquid to break scaling deposits. Immersing liquid may contain cavitation nucleus such as mall air bubbles or particles as known to the skilled man in the art. With reference to FIG. 13 and FIG. 14A this may be achieved by providing a suitable apparatus as part of the evaporator vessel 20. As shown in FIG. 13, a plurality of ultrasonic transducer elements 100 are shown. These may be provided in any suitable orientation or configuration. They may comprise ultrasonic transducers which are permanently mounted on a surface of the evaporator vessel 20, or may be removably mounted thereon, or alternatively the elements 100 may comprise ports within which the transducers may be received or mounted. To enable ultrasonic cleaning to function, the heat exchanging tube bundle must be immersed in a liquid bath. Accordingly, as shown at 101 in FIG. 14A, a suitable deflector is provided which is configured such that when the cavity 21 is filled with a sufficient supply of liquid, the deflector will enable the heat exchange tube bundle 22 to be immersed in liquid, and with suitable ultrasonic transducers 100 cleaned ultrasonically. In addition to the transducers 100, or alternatively, transducers may be installed internally of the evaporator, for example on the tube sheets 71, 72, the deflectors 44 or even along or between the heat exchanging tubes 70 of the bundle 22.

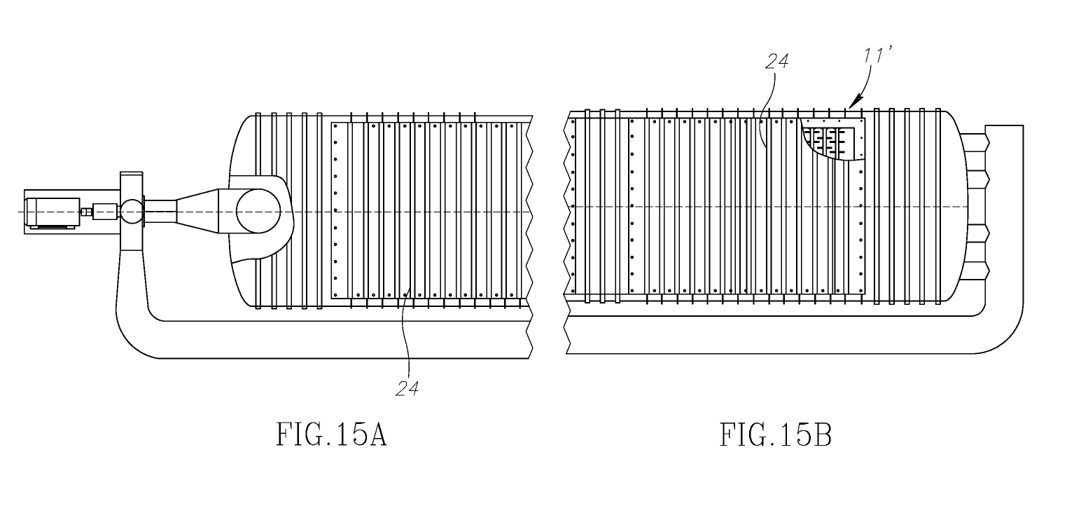

As shown in FIG. 14a, FIG. 14b, FIG. 15a and FIG. 15b, an evaporator 11′ may be provided which has two or more effects. The embodiment of FIG. 1 has a single effect but it will be apparent that a plurality of effects may be provided with any suitable configuration of the evaporator, or indeed series of evaporators sequentially connected with suitable compression. In the example of FIG. 14 and FIG. 15, separate heat exchange tube bundles 22 are provided, and separate hatches 24 corresponding to each effect are provided. It will be apparent that multiple effects could be provided under a single hatch such as that shown in FIG. 1.

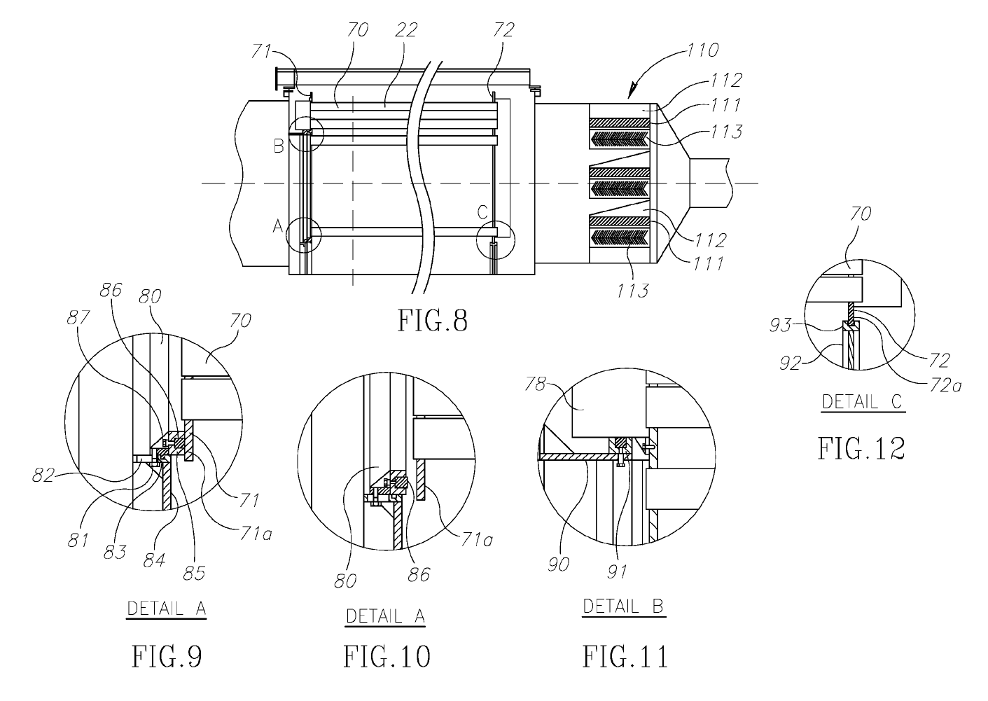

With reference to FIG. 8 and FIG. 14A, a demister is generally shown at 110. The purpose of the demister 110 is to remove entrained droplets of water from the steam stream before it passes to the compressor. The demister 110 comprises a plurality of horizontally extending demister knit mesh elements 111 supported by suitable flanges 112. Beneath the demister knit mesh elements 111, horizontally mounted demister louvers 113 are provided. The horizontal orientation permits a higher number of louvers to be introduced providing a higher effective surface area for the demister. Where a deflector 101 is provided, the more efficient demister 110 may help compensate for steam-baffling effects of the deflector 101. Water droplets connected on the demister 110 drop into the produced water. In order to maintain demister 110 clean and effective, a third and independent nozzle array may be added.

The evaporator assembly described herein is thus advantageous in a number of respects. Firstly, in the transport and installation of the evaporator, the compact “square-circle” design permits a suitably large heat exchange tube bundle having a large surface area to be used, whilst maintaining the strength of the evaporator vessel but also permitting the evaporator to be moved on a single vehicle. Installation of the evaporator and the associated compressor is simply a matter of conveying both to the site and mounting the evaporator and compressor on suitable frames or bases. In the embodiments where a hatch is provided, maintenance and on-line cleaning of the evaporator is noticeably enhanced.

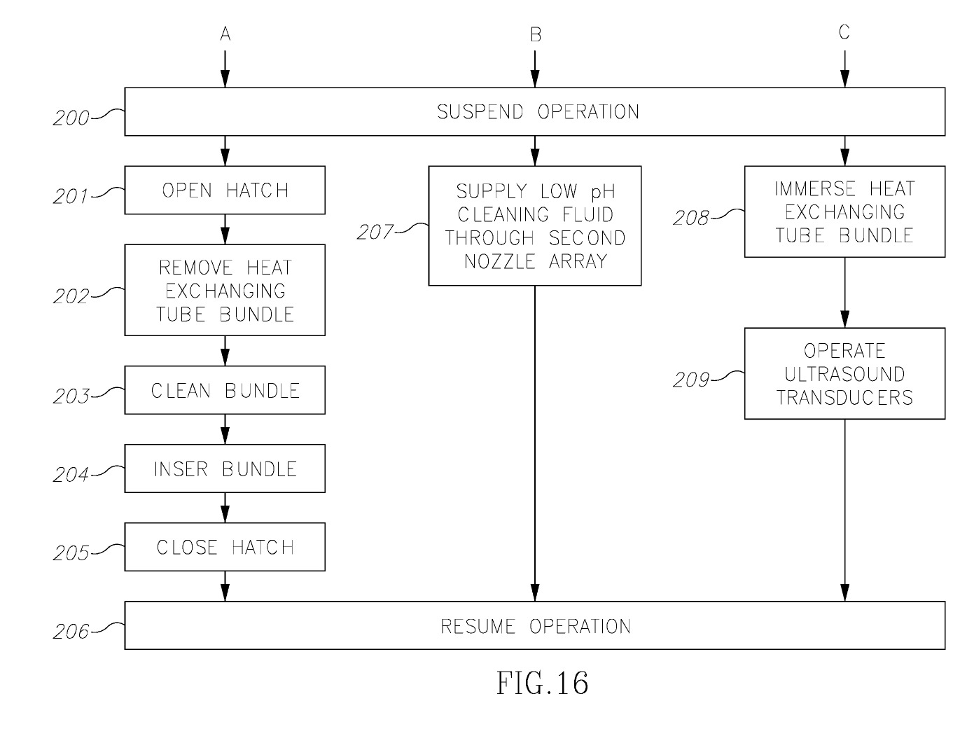

The alternative methods of cleaning the heat exchanging tube bundle are illustrated in FIG. 16, after suspending operation of the evaporator as shown at step 200. When external cleaning of the heat exchanger tube bundle 22 is required, shown as method (A), the bundle 22 may be simply removed by removing the hatch 24 (step 201) and lifting the bundle 22 out of the evaporator vessel 20, shown at step 202 and as illustrated in FIG. 7. The bundle 22 can then be transferred to an ultrasonic or high-flow cleaning system in straightforward manner as shown at step 203. It might be envisaged that a second, clean and operational, bundle 22 may be placed in the evaporator vessel 20 immediately to allow operation to resume as quickly as possible without waiting for the original bundle 22 to be cleaned, or the original cleaned bundle can be reintroduced, as shown at step 204. The hatch 24 is replaced in a sealing manner and the bolts 59 reattached (step 205) and evaporator operation can then resume (step 206).

In the embodiments where a second main feed 31 and second nozzle array 33b are provided, the bundle 22 may be cleaned in situ without removal. As shown at method B, the tube bundle 22 may be cleaned simply by supplying a suitable cleaning fluid, for example an acid solution with a relatively low pH, through the second main feed 31 and second nozzle array 33b (step 207). Cleaning fluid may be supplied at a suitable high rate to remove scaling and deposits from the bundle 22 and allow the bundle 22 to be cleaned without removal from the vessel 20. Following cleaning, operation can resume at step 206.

In the further alternative, shown as method C the bundle 22 may be cleaned in situ by filling the vessel 20 with liquid such that the bundle 22 is immersed, at step 208. An ultrasonic cleaning process using suitable ultrasonic transducers 100 mounted on and/or within the evaporator vessel 20 is shown at step 209.

In any of the alternatives, it will be apparent that the loss of production or operational time is kept to a minimum and cleaning and maintenance of the evaporator 11 and the heat exchanging tube bundle 22 performed quickly and efficiently.

It will be apparent that suitable evaporators may be provided having some or all of the features of any of the embodiments and alternatives discussed herein. For example, it may be apparent that an evaporator vessel 20 may be provided having the curved wall configuration but with an otherwise conventional heat exchanger configuration or an evaporator may be provided with a hatch 24 with no second main feed 31 or second nozzle array 33b. Alternatively, an evaporator may be provided with first and second main feed 30, 31 and first and second nozzle arrays 33A, 338, but without the provision of a hatch 24. Other combinations of features may be provided from any of the examples herein as needed or as advantageous. The evaporator may be provided with any suitable number of effects, whether one or two as shown in the embodiments here or, more, for example four, where a suitable compressor is provided.

It is particularly envisaged that an evaporator and evaporator assembly as described herein is suitable for use as part of a water recovery apparatus at an oil production plant, to clean produced water, but it will be apparent that the evaporator may be used as part of any other industrial plant or process.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding description. For example, flow need not move through each illustrated box or state, or in exactly the same order as illustrated and described.

Meanings of technical and scientific terms used herein are to be commonly understood as by one of ordinary skill in the art to which the invention belong, unless otherwise defined.

1. An evaporator for treating industrial waste water or produced water having an external vessel and an inner cavity, and a heat exchanging tube assembly, the external vessel comprising an opening closable by a hatch, the heat exchanging tube assembly comprising a first end tube sheet, a second end tube sheet and a plurality of heat exchange tubes received in the first end tube sheet and second end tube sheet and being insertable into and removable from the inner cavity through the opening, the evaporator further comprising a lifting frame, the lifting frame having a first end part for connection to the first end tube sheet, a second end part for connection to the second end tube sheet, and a rigid frame extending between the first end part and second end part, wherein the lifting frame is releasably connectable to the heat exchanging tube bundle to permit it to be inserted into or removed from the inner cavity.

2. An evaporator according to claim 1 wherein the hatch comprises a first upturned lip, and a wall adjacent the hatch comprises a second upturned lip, wherein the first and second upturned lips abut when the hatch closes the opening.

3. An evaporator according to claim 1 wherein the hatch comprises a first connection plate, and a wall adjacent the hatch comprises a second connection plate, and wherein a plurality of connection elements engage the first connection plate and second connection plate to maintain the hatch in a closed position.

4. An evaporator according to claim 3 wherein the connection elements comprise a plurality of bolts.

5. A evaporator according to claim 3 wherein the connection elements are mounted such that the total vector of forces on the hatch and the adjacent wall extends generally longitudinally of the connection elements.

6. An evaporator according to claim 3 wherein a sealing element is engaged between the first connection plate and second connection plate.

7. An evaporator according to claim 1 comprising support elements disposed in the cavity to engage the first end tube sheet and second end tube sheet.

8. An evaporator according to any one of the preceding claims comprising a plurality of openings, each opening closable by a hatch.

9. An evaporator for treating industrial waste water or produced water, having a heat exchanging tube array, and a first plurality of nozzles disposed to introduce water to the heat exchanging tube array during normal operation, the evaporator comprising a second plurality of nozzles, the second plurality of nozzles being disposed to introduce cleaning fluid to the heat exchanging tube array during cleaning operation, wherein the first plurality of nozzles are located to form a falling film of water over the heat exchanging tube bundle, and wherein the second plurality of nozzles are offset from the first plurality of nozzles.

10. An evaporator according to claim 9 comprising a first main feed connected to the first plurality of nozzles and a second main feed connected to the second plurality of nozzles.

11. An evaporator according to claim 10 wherein the evaporator comprises an external vessel having an opening closable by a hatch, wherein the first main feed and second main feed are mounted on the hatch.

12. An evaporator according to claim 10 wherein the evaporator comprises an external vessel having an opening closable by a hatch, wherein at least some of the first plurality of nozzles and the second plurality of nozzles are mounted on the hatch.

13. An evaporator according to claim 9 wherein the second plurality of nozzles further comprises nozzles to direct fluid at the sides of the heat exchanging tube array.

14. An evaporator for treating industrial waste water or produced water, comprising an external vessel having a longitudinal axis, the vessel comprising a plurality of longitudinal extending walls, said longitudinally extending walls being curved in a plane transverse to said longitudinal axis and an opening closable by a hatch, wherein the hatch comprises a first upturned lip, and a wall adjacent the hatch comprises a second upturned lip, wherein the first and second upturned lips abut when the hatch closes the opening, the hatch further comprising a first connection plate, and a wall adjacent the hatch comprises a second connection plate, and wherein a plurality of connection elements engage the first connection plate and second connection plate to maintain the hatch in a closed position.

15. An evaporator according to claim 14 wherein the plurality of walls comprises a base wall and opposed side walls

16. An evaporator according to claim 14 wherein the base wall and opposed side walls wherein the base wall and opposed side walls are formed integrally.

17. An evaporator according to claim 14 wherein the opposed side walls are welded to the base wall.

18. An evaporator according to claim 14 wherein the hatch comprises a curved top wall.

19. An evaporator according to claim 14 wherein the connection elements comprise a plurality of bolts.

20. A evaporator according to claim 14 wherein the connection elements are mounted such that the total vector of forces on the hatch and the adjacent wall extends generally longitudinally of the connection elements.

21. An evaporator according to claims 14 wherein a sealing element is engaged between the first connection plate and second connection plate.

22. An evaporator according to claim 14 wherein the evaporator comprises a single preassembled and transportable module using a standard vehicle.

23. An evaporator according to claim 14 comprising a compressor having an inlet.

24. An evaporator according to claim 22 comprising a demister to remove entrained water droplets before the inlet.

25. An evaporator according to claim 24 wherein the demister comprises a plurality of horizontal louvers.

26. An evaporator according to claim 24 comprising a plurality of horizontal knitmesh elements.

27. An evaporator according to claim 1 comprising a plurality of effects, each effect comprising a heat exchanging tube bundle and an associated plurality of nozzles.

28. An evaporator according to claim 1 comprising a plurality of ultrasonic transducers to permit ultrasonic cleaning of the heat exchanging tube bundle.

29. An evaporator according to claim 28 comprising an inner cavity and a deflector plate to retain fluid within the inner cavity to immerse the heat exchanging tube bundle to permit ultrasonic cleaning.

30. An oil production apparatus, the oil production apparatus comprising a water recovery apparatus, the water recovery apparatus comprising an evaporator array according to claim 1.

31. An oil production apparatus, the oil production apparatus comprising a water recovery apparatus, the water recovery apparatus comprising an evaporator array according to claim 11.

32. An oil production apparatus, the oil production apparatus comprising a water recovery apparatus, the water recovery apparatus comprising an evaporator array according to claim 14.
